(19) United States
(12) Patent Application Publication
(10) Pub. No.: US 2023/0041574 A1
(43) Pub. Date: Feb. 9, 2023

(54) SYSTEM AND METHOD FOR PURIFYING WATER

(71) Applicant: Diagonals Technologies Limited Liability Company, Comfort, TX (US)

(72) Inventor: Nicholas Brown, San Antonio, TX (US)

(21) Appl. No.: 17/751,510

(22) Filed: May 23, 2022

Related U.S. Application Data
(60) Provisional application No. 63/191,452, filed on May 21, 2021.

(51) Int. Cl. C02F 1/461; C02F 1/467

(52) U.S. Cl. CPC C02F 1/46104; C02F 1/467; C02F 2201/4612; C02F 2201/46115; C02F 2209/005; C02F 2303/04

(57) ABSTRACT

A water purification electrolytic generator apparatus provides clean drinking water to users. An electrolyte is added to water/other liquid exposed to the electrolytic generator apparatus in order to create an environment suitable for the apparatus to function . Residing in a housing of the apparatus is an enclosed first electrode (cathode) printed on a printed circuit board, a second electrode (anode), and a membrane separating the cathode and anode/printed circuit board. A control circuit including the printed circuit board electrically connects the anode and cathode to a power source, which is located external to the interior of the container. The incorporation of the printed circuit board reduces costs and improves portability so that the water purification system can provide drinkable water to users in different circumstances. A system including the apparatus may further include a container housing the electrolytic generator apparatus, a lid, and a stand. A filter is positioned in the container to filter water poured into the container.

### FIELD OF THE INVENTION

The disclosure relates generally to electrolytic generators, and more specifically to electrolytic generators for purifying liquids.

### BACKGROUND OF THE INVENTION

Electrolytic generators are well known devices that are typically utilized in the efficient maintenance of pools. An additional important use for these devices includes water purification. In order to purify the water, an electrolytic reaction must occur in the water to be purified, which means that the proper parameters must be set up in order to create the outcome of clean water. To have this occur, an electrolyte, such as salt, may be added to the water to make the water more conductive. A power source then runs a current through the cathode and anode of the electrolytic generator so that the sodium and chlorine ions can separate from one another and the chlorine ions ultimately form chlorine gas and other chlorinated compounds that are capable of cleaning and purifying the water.

Many electrolytic generator components are large and expensive and are typically intended to be utilized to clean large collections of water, such as pools. Those and other electrolytic generator setups may also include separate hardware and control modules, which can lead to cumbersome installation and may not at all be portable. In addition, it would be infeasible for these components to be utilized to purify water for drinking, which would be much smaller of a quantity and may require a shorter purification turnaround time depending on the thirst of individuals. This essentially eliminates the ability for these components to be utilized in makeshift water purification systems utilized in places such as third world countries due to space constraints and costs.

### BRIEF SUMMARY OF THE INVENTION

The disclosed subject matter provides a water purification electrolytic generator apparatus. An electrolyte is added to water/another liquid to create an environment suitable for an electrolytic generator to function in relation to the water. Residing in the housing of the electrolytic generator apparatus is an enclosed first electrode (cathode) printed on a printed circuit board, a second electrode (anode), and a membrane separating the cathode and anode/printed circuit board. A control circuit including the printed circuit board electrically connects the anode and cathode to a power source, which is located external to the interior of the container.

In another embodiment, the housing of the electrolytic generator apparatus may comprise a fastening component that may allow a portion of the electrolytic generator to be submerged in the water of the container and a portion of the electrolytic generator to be exposed outside of the container. This configuration may allow for the electrolysis to take place in the container, may allow connectors to stay dry and connected to wiring affixed to the power source, and may allow for the escape of hydrogen gas out of the water via a vent. In addition, the electrolytic generator may also be easily removable from a container once the electrolytic generator needs to be replaced.

In another embodiment, the electrolytic generator apparatus may include a plurality of vents. The vents may be positioned adjacent orifices and are positioned as such to provide passageways for hydrogen formed from electrolytic reactions to escape from the housing of apparatus.

A method is further provided for manufacturing an electrolytic generator. The method includes providing a circuit board. A first electrode is then printed onto one side of the circuit board and may act as a cathode. A membrane is positioned adjacent the cathode and a second electrode (anode) is positioned on the side of the membrane opposite the side of the membrane facing the cathode. The anode is then fastened to the circuit board via conductive fasteners so that the anode, cathode, and circuit board are electrically connected. The components above are then positioned in a fastenable housing.

In another embodiment, a method is provided for disinfecting water. The method may include providing a container having an electrolytic solution and an electrolytic generator housing a printed circuit board (PCB). A power source may be provided, affixed to the electrolytic generator, and activated to start the electrolytic reaction in the container. The electrolytic reaction may then be allowed to occur for a preset amount of time based on the configuration/componentry of the printed circuit board.

In another embodiment, a method is provided for disinfecting water. The method may include providing a container having a filter and an electrolytic generator housing a circuit board and connected to a power source. Unsanitized water may be poured through the filter of the container. When the water is being poured through the filter, biologically inactive compounds are removed. Once this is complete, an electrolyte may be added to the water and a power source may be activated in order to start an electrolytic reaction in the container. During the time that the electrolytic reaction occurs, biologically active compounds are removed from the water, leaving an end product of purified water.

### BRIEF DESCRIPTION OF THE DRAWINGS

The disclosed subject matter, objectives, and advantages thereof, will best be understood by reference to the following detailed description of an illustrative embodiment when read in conjunction with the accompanying drawings, wherein:

FIG. 1A displays a top perspective view of an electrolytic generator apparatus in accordance with embodiments.

FIG. 1B displays a bottom perspective view of an electrolytic generator apparatus in accordance with embodiments.

FIG. 1C displays a side view of an electrolytic generator apparatus in accordance with embodiments.

FIG. 1D displays an alternative side view of an electrolytic generator apparatus in accordance with embodiments.

FIG. 1E displays a top perspective view of an electrolytic generator apparatus including through holes in accordance with embodiments.

FIG. 1F displays a bottom perspective view of an electrolytic generator apparatus including through holes in accordance with embodiments.

FIG. 1G displays a sectional view of an electrolytic generator in accordance with embodiments.

FIG. 1H displays a sectional view of an electrolytic generator including vent apparatuses in accordance with embodiments.

FIG. 2A displays a top view of a first embodiment of an anode.

FIG. 2B displays a top view of a second embodiment of an anode.

FIG. 3A displays a top view of a first embodiment of an exposed anode surface.

FIG. 3B displays a top view of a second embodiment of an exposed anode surface.

FIG. 3C displays a top view of a third embodiment of an exposed anode surface.

FIG. 3D displays a top view of a fourth embodiment of an exposed anode surface.

FIG. 3E displays a top view of a fifth embodiment of an exposed anode surface.

FIG. 4A displays a bottom view of a printed circuit board (PCB) of an electrolytic generator in accordance with embodiments.

FIG. 4B displays a top view of a printed circuit board (PCB) of an electrolytic generator in accordance with embodiments.

FIG. 4C displays a side view of a printed circuit board (PCB) of an electrolytic generator including a molex connector in accordance with embodiments.

FIG. 4D displays a perspective view of a printed circuit board (PCB) of an electrolytic generator including a molex connector in accordance with embodiments.

FIG. 5A displays a diagrammatic view of a first embodiment of a circuit diagram.

FIG. 5B displays a diagrammatic view of a first embodiment of a circuit diagram having an operation indicator.

FIG. 6 displays a deconstructed view of an electrolytic generator in accordance with embodiments.

FIG. 7A displays a reference designator diagram of a printed circuit board (PCB) in accordance with embodiments.

FIG. 7B displays a top copper layer of a printed circuit board (PCB) in accordance with embodiments.

FIG. 7C displays a top solder mask of a printed circuit board (PCB) in accordance with embodiments.

FIG. 8A displays a first printing layer of a printed circuit board (PCB) in accordance with embodiments.

FIG. 8B displays an exposed nickel treated cathode layer of a printed circuit board (PCB) in accordance with embodiments.

FIG. 9A displays a perspective view of an alternative electrolytic generator in accordance with embodiments.

FIG. 9B displays a top view of an alternative electrolytic generator in accordance with embodiments.

FIG. 10 displays a sectional view of an alternative electrolytic generator configured to sanitize liquids in a handheld liquid container in accordance with embodiments.

FIG. 11A displays a perspective view of a water purification system in accordance with embodiments.

FIG. 11B displays an interior view of a water purification system in accordance with embodiments.

FIG. 12A displays a perspective view of an alternative water purification system in accordance with embodiments.

FIG. 12B displays a side sectional view of an alternative water purification system in accordance with embodiments.

FIG. 12C displays a top view of an alternative water purification system in an open configuration in accordance with embodiments.

FIG. 12D displays a bottom view of a lid of an alternative water purification system in accordance with embodiments.

FIG. 13A displays a perspective view of an alternative water purification system including configurable side panels in accordance with embodiments.

FIG. 13B displays a partial side sectional view of an alternative water purification system in accordance with embodiments.

FIG. 13C displays a side view of a base of an alternative water purification system in accordance with embodiments.

FIG. 13D displays a partial side view of an alternative water purification system in accordance with embodiments.

FIG. 13E displays a partial sectional view of a base of alternative water purification system including configurable side panels in accordance with embodiments.

FIG. 14 displays a method for manufacturing an electrolytic generator.

FIG. 15 displays a method for disinfecting water.

FIG. 16 displays an alternative method for disinfecting water.

FIG. 17 displays a method for assembling an electrolytic generator apparatus.

### DETAILED DESCRIPTION

Reference now should be made to the drawings, in which the same reference numbers are used throughout the different figures to designate the same components.

It will be understood that, although the terms first, second, third, etc. may be used herein to describe various elements, these elements should not be limited by these terms. These terms are only used to distinguish one element from another element. Thus, a first element discussed below could be termed a second element without departing from the teachings of the present disclosure.

The terminology used herein is for the purpose of describing particular embodiments only and is not intended to be limiting. As used herein, the singular forms "a", "an", and "the" are intended to include the plural forms as well, unless the context clearly indicates otherwise. It will be further understood that the terms "comprises" and/or "comprising" or "includes" and/or "including" when used in this specification, specify the presence of stated features, regions, integers, steps, operations, elements, and/or components, but do not preclude the presence or addition of one or more other features, regions, integers, steps, operations, elements, components, and/or groups thereof.

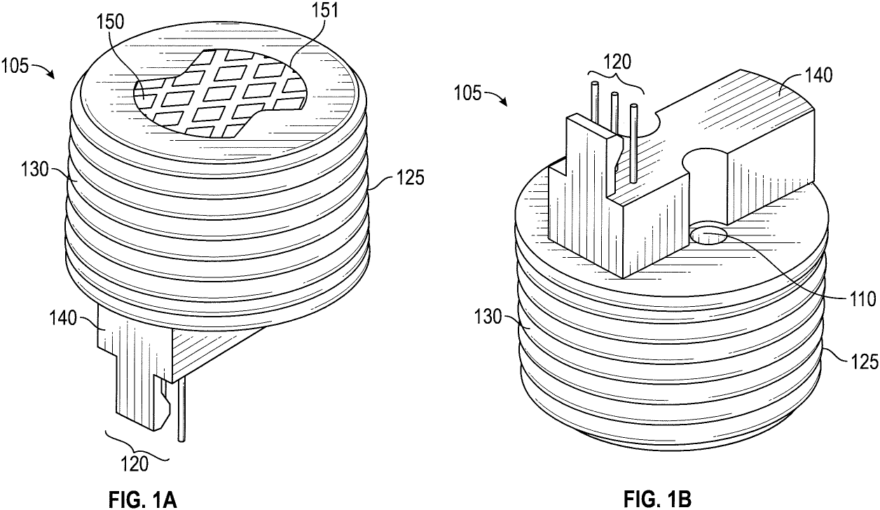

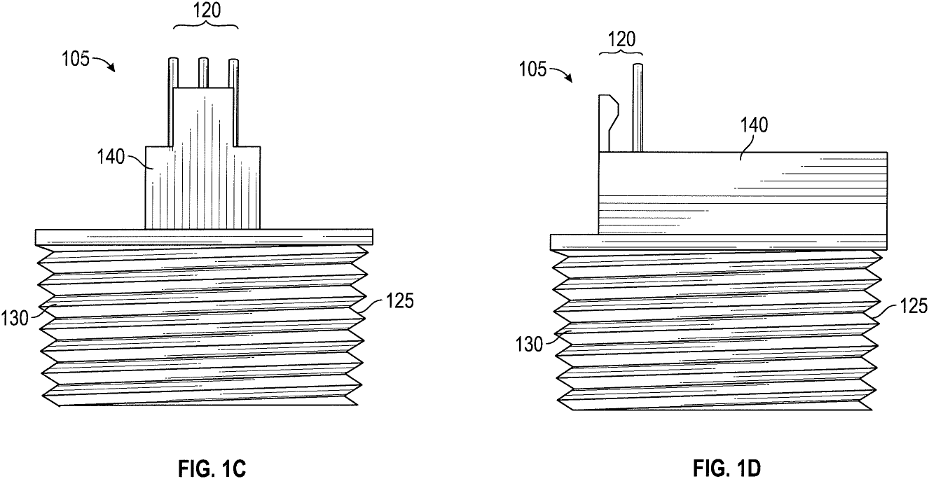

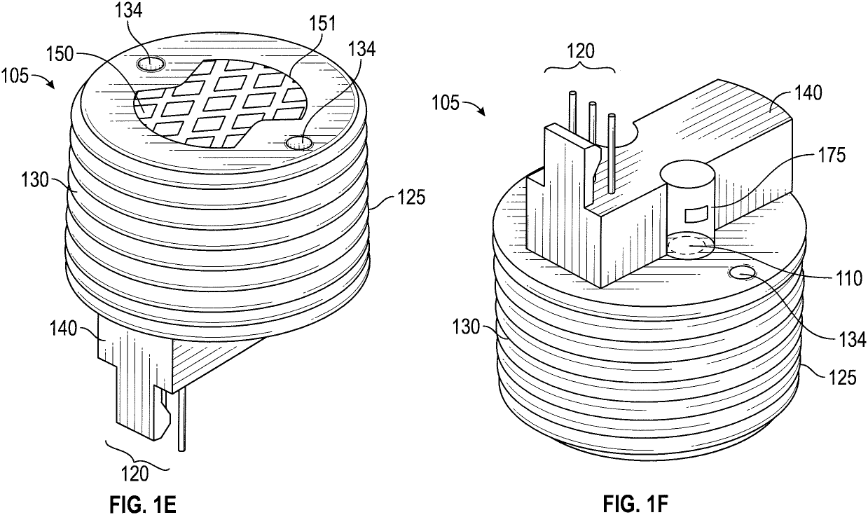

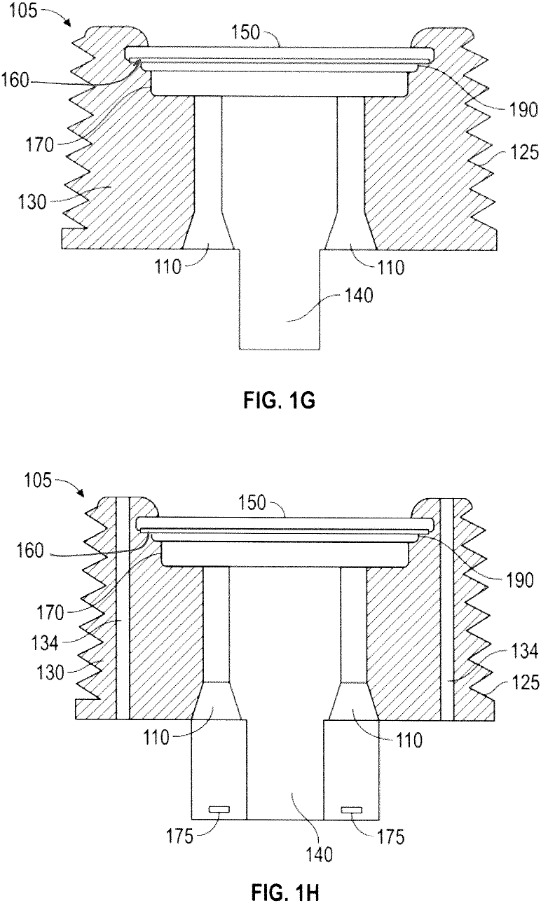

FIG. 1A displays a top perspective view of an electrolytic generator apparatus 105 in accordance with embodiments. The housing 125 of electrolytic generator apparatus 105 may include first and second ends, an upper housing 130, and a lower housing 140 and may, in embodiments, be made of a polymeric material. Upper housing 130 may include a fastening means to affix the electrolytic generator apparatus 105 to container 10. In this embodiment, the fastening means is a set of threads positioned around a sidewall of housing 125 that may interlock with another set of threads associated with container 10 or any other container that contains liquid. On an upper side of the upper housing 130, an opening 151 is positioned so that anode 150, positioned adjacent opening 151, is exposed to electrolytic solution and cathode 190 is indirectly exposed to the electrolytic solution. It is noted that anode 150 and cathode 190 may be referred to as electrodes.

As shown in FIG. 1G, cathode 190 is separated from anode 150 via membrane 160 and is internally contained within upper/lower housing 130/140 as opposed to being exposed like anode 150. Anode 150 and cathode 190 are positioned as such so that when electrolysis occurs in an electrolytic solution containing anode 150 and cathode 190, sodium ions are separated from the salt in the solution and are attracted towards cathode 190 (which is positively charged) and chlorine ions are separated from the salt and are attracted towards negatively charged anode 150 (which turns into chlorine gas and other chlorine compounds that may disinfect the water). In addition, hydrogen is an additional byproduct that is given off in the form of a gas and is led out of the bottom of lower housing 140 through vent channels 110 associated with cathode 190. Additionally shown in FIG. 1H is the embodiment of apparatus 105 of FIG. 1E including a pair of vent apparatuses 175. Vent apparatuses 175 may be positioned adjacent vent channels 110 so that each of the connections between matching vent apparatuses 175 and vent channels 110 are waterproof/watertight. Vent channels 110 may allow the hydrogen generated from cathode 190 (via associated orifices in printed circuit board (PCB) 170) to vent and then be diffused back into the water via the vent apparatuses 175 which, in embodiments, may comprise gas diffusion layer (GDL) hydrogen vents incorporating one-way valves. An alternative view of vent apparatus 175 is shown in FIG. 1F positioned above vent channels 110 and adjacent lower housing 140.

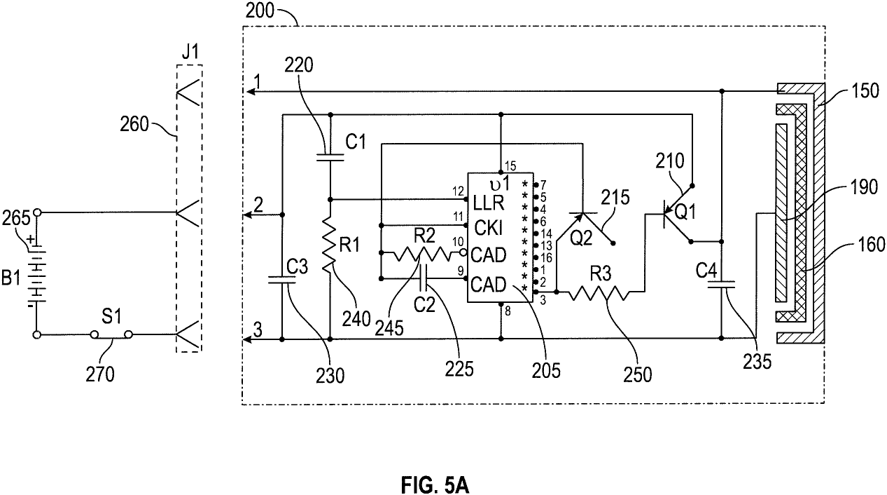

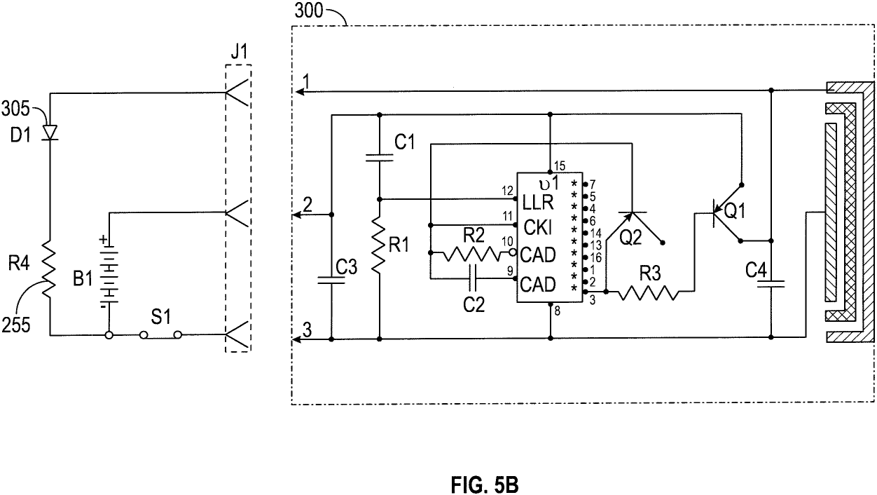

As shown in FIG. 1B, the vent channels 110 exit out of an end of upper housing opposite anode 150. Lower housing 140, as shown, is configured to provide an uninhibited exit for hydrogen exiting vent channels 110. In addition (and as shown in FIGS. 1A, 1C, and 1D), a pinheader 120 (and associated engagement clip integrated with lower housing 140) may protrude from lower housing 140 so that an electrical connection may be easily made between anode 150, cathode 190, and power source 60. In order to form an electrical connection with power source 60, pinheader 120 and the engagement clip may engage a female connector 260 (see FIGS. 5A and 5B) wired to power source 60. Once engaged, pinheader 120 may then receive a continuous source of power from power source 60 that may be utilized to carry out an electrolysis reaction.

In embodiments, housing 125 may comprise a polyvinyl acetate (PVC) that may allow housing to be utilized for electrochemical processes for 25 years. In further embodiments, housing 125 may comprise a biodegradable polymer such as, but not limited to: polycaprolactone (PCL), polyester amide (PEA), polyethylene oxide (PEO), polyethylene glycol (PEG), poly (propylene carbonate) (PPC), polylactic acid (PLA), poly (butylene succinate) (PBS), polyhydroxyalkanoates (PHA), curdlan, pullulan, cellulose, polysaccharide, and chitosan. In other embodiments, at least one of upper housing 130 and lower housing 140 may comprise a flexible rubber casing. In other embodiments, upper housing 130 and lower housing 140 (housing 125) may be machined as a single part.

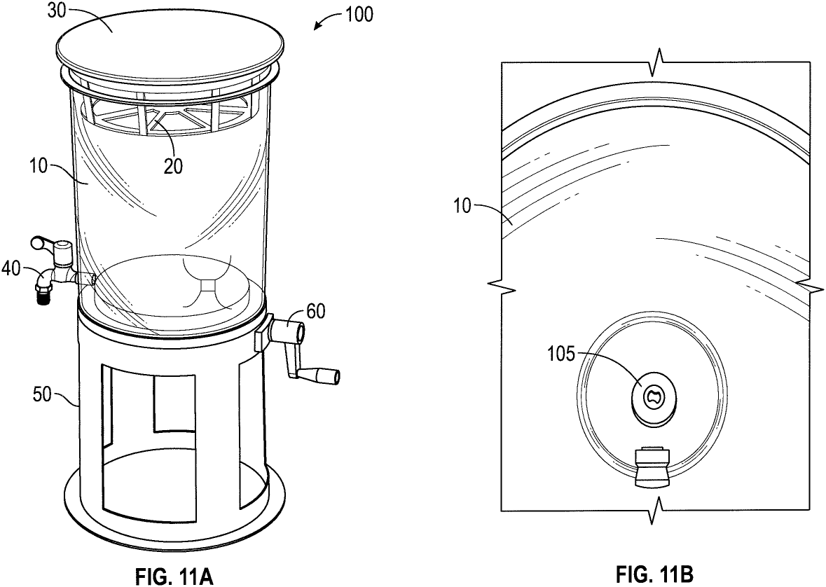

In an alternative embodiment of electrolytic generator apparatus 105 as shown in FIGS. 1E, 1F and 1H, through holes 134 may extend from one end of upper housing 130 to the other end of upper housing 130 in order to allow diffused hydrogenated water to access a container it is affixed to (such as, but not limited to, container 10 of FIGS. 11A and 11B).

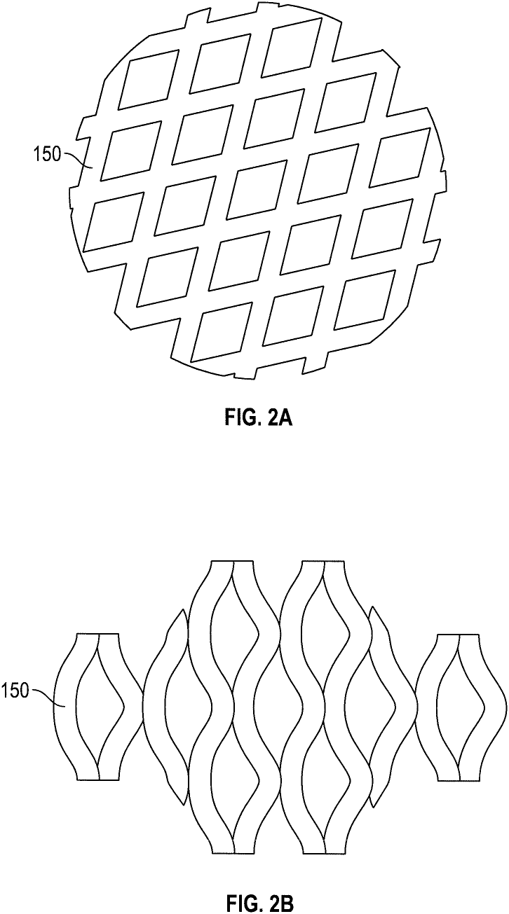

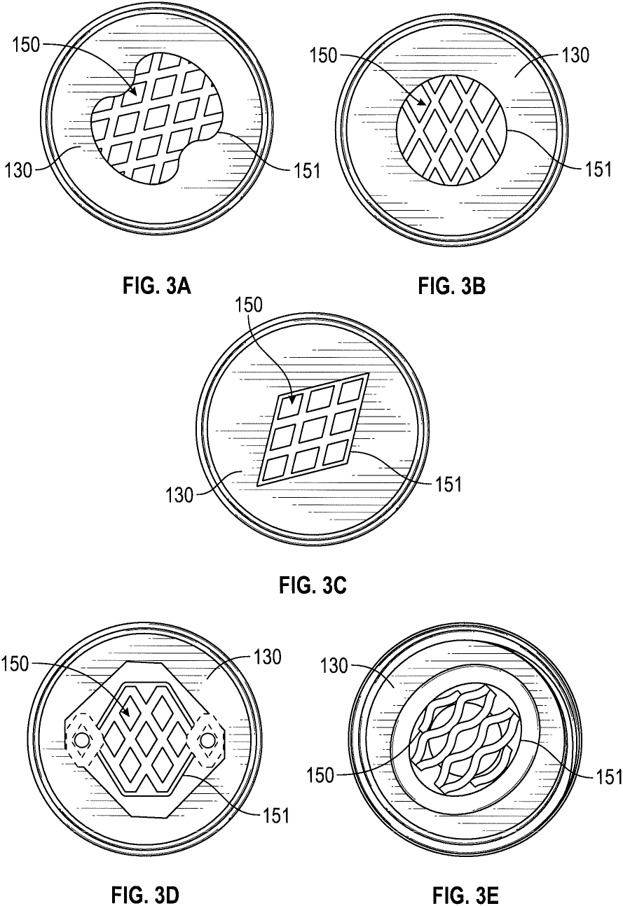

FIGS. 2A and 2B display top views of a multiple embodiments/configurations of anode 150. Anode 150 may be configured in a mesh form so that sodium may pass through once electrolysis occurs within container 10. In addition, the mesh configuration may allow for ease of attachment to conductive fasteners 156 (which may be inserted between interconnected strips of anode 150. The size and configuration of the mesh of the anode 150 may be a factor in determining the efficiency and/or rate at which the electrolysis occurs. FIGS. 3A to 3E show the anodes 150 affixed to upper housing 130 with different shaped openings 151 exposing anode 150 (in a working environment, to electrolytic solution). The shape of the openings 151 may also assist in determining the efficiency and/or rate at which the electrolysis occurs. Upper housing 130 adjacent opening 151 may also assist in protecting the conductive fasteners 156 from degradation by concealing the conductive fasteners 156 to the electrolytic solution. In embodiments, anode 150 found in FIG. 2A may comprise a width of 0.75 inches and a thickness of 0.025 inches. In embodiments, anode 150 found in FIG. 2B may comprise a width of 0.752 inches. In further embodiments, anode 150 may comprise iridium ruthenium coated titanium.

In further embodiments, the body of anode 150 may comprise a fabric substrate or porous metal, as opposed to a mesh metal substrate. When utilized as a fabric, anode 150 may be impregnated/treated with catalysts in order to increase the rate of the electrolysis. Membrane 160 may, in additional embodiments, be impregnated/treated with catalysts in order to provide a similar result. More specifically, in embodiments, anode 150 may comprise at least one of titanium fiber felt and a titanium porous transport layer. These configurations may be coated with one or more catalysts that may be relevant to an oxygen evolution reaction and may include, but is not limited to platinum and a mixed oxide catalyst. Catalysts may be coated directly onto the felt or porous transport layer of anode 150 via ultrasonic spraying or any other mixed oxide catalyst application process. When the catalyst is applied directly to anode 150 or membrane 160, the overpotential of the system in which the electrolysis is run may be significantly reduced and may also increase the efficacy of the apparatus 105 in terms of electro-chemical processing (as an electrolytic cell using the chloralkali process and electrical processing). In addition, a fabric substrate or porous metal utilized for anode 150 may inherently be more porous and have a higher surface contact with the electrolytic solution, resulting in a higher conductivity between membrane 160 and cathode 190 as well as a more efficient chemical/electrolytic reaction. Use of the fabric substrate or porous metal as anode 150 may also remove the threat of additionally generated heat (thermal runaway) that typically is a risk posed by a solid titanium anode 150. Furthermore, utilization of a fabric substrate for anode 150 may increase the electrical efficiency of anode 150 due to the fabric not having a half reaction which may typically be seen in a solid titanium anode 150.

Additionally, in embodiments, cathode 190 and anode 150 may be electrically connected to a semi-submersible microchip via one or more rigid-flex PCBs.

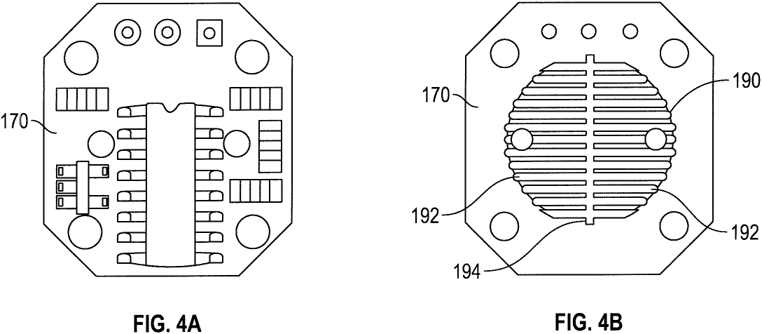

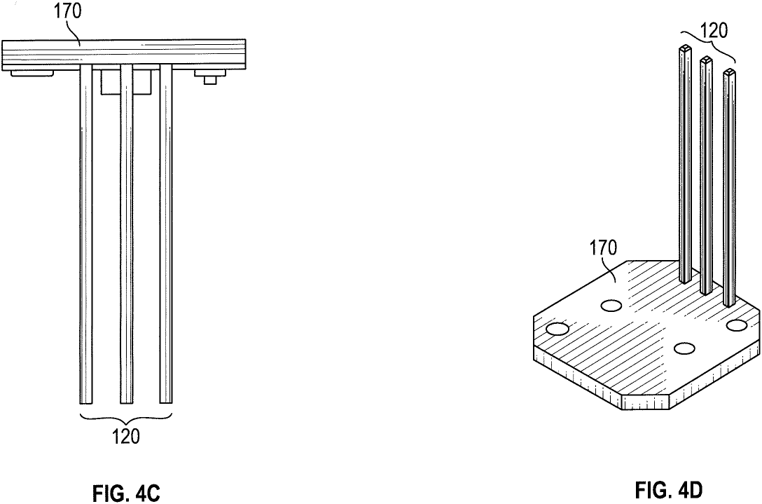

FIG. 4A displays a bottom view of a printed circuit board (PCB) 170 of an electrolytic generator apparatus 105 in accordance with embodiments. The bottom side of PCB 170 shows a number of electrical components that are efficiently positioned on one side of PCB 170 (discussed further in FIGS. 5A and 5B) while the top side of PCB 170 (FIG. 4B) includes printed cathode 190 electrically affixed to the top side of PCB 170 (it is noted that the top side of PCB 170 may be the side adjacent membrane 160 when positioned within electrolytic generator apparatus 105). The configuration of cathode 190 may include a spine 194 that runs down the center of PCB 170. Ribs 192 extend perpendicularly outward from spine 194 towards opposite ends of PCB 170. Ribs 192 and spine 194 may act as a place for conductive spacer 152 to be positioned against when apparatus 105 is fully assembled.

In order for an electrolytic reaction to occur in container 10, cathode 190 must be of a sufficient area in order to provide enough electrical conductance for the sodium ions to separate from the chloride ions in the salt. As shown in FIGS. 4C and 4D, pinheader 120 is positioned on the top side of the circuit board 170 at the three orifices found at the top end of PCB 170 as found in FIGS. 4A and 4B; pinheader 120 may link the circuit to power source 60 via a female connector 260 (FIGS. 5A and 5B). Pinheader 120 may act as a liaison between the electrolytic environment and power source 60. In embodiments, PCB 170 may comprise a width of 0.66 inches and a thickness of 0.031 inches. In certain embodiments, PCB 170 may comprise at least one of a flex and a rigid-flex configuration. These configurations may ease installation as well as reduce costs associated with manufacturing PCB 170. Additionally, the flex/rigid-flex embodiments of PCB 170 may also be encased in a polymer such as, but not limited to non-BPA silicone and non-BPA plastic, in order to waterproof timer circuit 205.

FIG. 5A displays a diagrammatic view of a first embodiment of a circuit diagram 200. PCB 170 is electrically connected to both anode 150 and cathode 190 so that electricity sent to anode 150 and cathode 190 are first run through the components found on the top side of PCB 170. The components may include the following: timer circuit 205, first transistor 210, second transistor 215, first capacitor 220, second capacitor 225, third capacitor 230, fourth capacitor 235, first resistor 240, second resistor 245, third resistor 250, female connector 260, battery 265, and switch 270. Switch 270 may be utilized as a reset for timer circuit 205. Switch 270 may momentarily disconnect power to timer circuit 205 when actuated and subsequently released. As a result, the abrupt voltage change may cause first capacitor 220 and first resistor 240 to generate an active-high pulse to reset timer circuit 205. After resetting, timer circuit 205 may begin counting and its count may be rippled through the circuit until its QN pin (pin of pinheader 120 designated as an arrow and a "3" on the lower left portion of circuit diagrams 200,300 of FIGS. 5A and 5B) is raised high to turn on second transistor 215 and effectively stop RC oscillator circuit. During the counting of timer circuit 205, its QN pin stays low and effectively turns on first transistor 210 to connect power to anode. Third resistor 250 may serve as a base resistor configured to limit current flowing into the base of first transistor 210. In addition, third capacitor 230 and fourth capacitor 235 may be configured to stabilize voltage transient.

FIG. 5B displays a diagrammatic view of a second embodiment of a circuit diagram 300 having an operation indicator 305. The second embodiment 300 includes components that are similar to the numbered components in the first embodiment and may include timer circuit 205, first transistor 210, second transistor 215, first capacitor 220, second capacitor 225, third capacitor 230, fourth capacitor 235, first resistor 240, second resistor 245, third resistor 250, female connector 260, battery 265, and switch 270. In addition, in this embodiment, an operation indicator 305 (such as, but not limited to, an LED) may be positioned between female connector 260 and fourth resistor 255. In order to let the user of water purification system 100 know that electrolysis is occurring in container 10, operation indicator 305 (as the embodiment of an LED) may light up as current flows through the circuit.

In embodiments, timer circuit 205 may be a binary ripple counter. More specifically, timer circuit 205 may be a 14-stage binary counter. Timer circuit 205 may keep track of the time that current is run through anode 150 and cathode 170. In addition, second capacitor 225 and second resistor 245 may be configured as an RC oscillator circuit for timer circuit 205. The capacitance of second capacitor 225 and the resistance of second resistor 245 may be combined to determine an active time interval of timer circuit 205.

In embodiments, first and second embodiments 200,300 may include specific componentry in order to effectively carry out the electrolysis process as well as any other electronic function disclosed. These components may include: a 14 stage binary counter (timer circuit 205), a first PNP transistor similar to type 2N3906 (first transistor 210), a second PNP transistor similar to type 2N3906 (second transistor 215), a first ceramic chip capacitor 0.010 uf (30 second run time) or 0.022 uf (60,120 second run time) +/- 10%, size 12 (first capacitor 220), a second ceramic chip capacitor 0.022 uf, +/- 10%, size 12 (second capacitor 225), a third ceramic chip capacitor 0.010 uf, +/- 10%, size 12 (third capacitor 230), a fourth ceramic chip capacitor 0.010 uf, +/- 10%, size 12 (fourth capacitor 235), a first resistor having 1/10W, 392 kiloohms, size 12 (first resistor 240), a second resistor having 1/10W, 196 kiloohms (30,60 second run time) or 392 kiloohms (120 second run time), size 12 (second resistor 245), a third resistor having 1/10 W, 10 kiloohms, size 12 (third resistor 250), a three position locking polarized female connector, molex 22-01-3037 or equivalent (female connector 260), a 9-12 volt DC, 600 mAh or regulated power supply (battery 265) and a push button on/off (switch 270).

In certain embodiments, time circuit 205 may control the run time of electrolysis; time intervals of electrolysis may include 30 second, 60 second, and 90 second bursts. The amount of time in which electrolysis occurs may be directly related to the volume of water contained in container 10. For example, timer circuit 205 may allow the electrolysis to run for a 90 second burst when the volume of water that needs to be purified is three gallons.

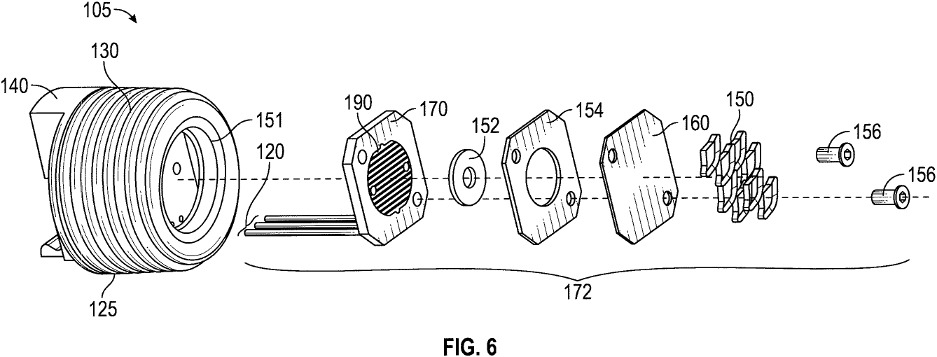

FIG. 6 displays a deconstructed view of an electrolytic generator apparatus 105 in accordance with embodiments. Housing 125 (first and second housings 130,140) may act as a capsule for the rest of the components of electrolytic generator apparatus 105. Pinheader 120 and PCB 170 may be positioned within the housing 125 with the pinheader 120 being inserted before PCB 170 following (through orifice 151) so that pinheader 120 may extend out of orifices on an end of housing 125 (see FIGS. 1A-1F) in order to connect to female connector 260 and indirectly, battery 265. With the bottom of PCB 170 facing inward and cathode 190 facing outward toward opening 151, conductive spacer 152 (which, in embodiments, may be a washer) is placed on top of cathode 190 and gasket 154 is placed on the outside of conductive spacer 152 in order to secure conductive spacer 152 in place and provide insulative properties to apparatus 105. Membrane 160 may then be positioned on top of conductive spacer 152 and gasket 154 while anode 150 is positioned on top of membrane 160. Fasteners 156 are conductive and may be positioned through holes (coated for conduction purposes) found in anode 150, membrane 160, gasket 154, and PCB 170 so that an electrical connection may be made between power source 60 and anode 150. It is noted that element 172 may include componentry of apparatus 105 that does not include housings 130,140. Element 172 may be collectively referred to as "chip 172" and may include molex connector 120, anode 150, conductive spacer 152, gasket 154, fasteners 156, membrane 160, circuit board 170, and cathode 190.

As an exemplary embodiment, chip 172, when connected to power source 60, may be configured to sterilize three gallons of water in 90 seconds of operation after sodium chloride (NaCl) is added to the three gallons of water at a maximum concentration of 5 milliliters (0.18 imp. fl oz/0.17 US fl oz maximum) or roughly 3200 ppm maximum of NaCl for every gallon of water.

In embodiments, membrane 160 may comprise a cation exchange membrane (CEM), and more specifically, may comprise a proton exchange membrane (PEM). Membrane 160 may be configured to be selectively permable to cations and, more specifically, to protons moving from the anode to the cathode. In further embodiments, membrane 160 may comprise a high conductivity (0.2 Siemens/cm or greater) so that membrane 160 may be stable in both oxidative and reductive environments. Membrane may also comprise a minimum cell operation of 1.23 Volts so that the voltage is large enough to oxidize water to O₂ gas. In addition, membrane 160 may be configured to be durable enough to operate on a high on/off cycle over a long period of time.

In embodiments, membrane 160 may be made of a fluorinated polymer such as, but not limited to, NAFION® (a registered trademark of Dupont). In embodiments, gasket 154 may be made of polymer such as, but not limited to, PORON® (a registered trademark of Rogers Corporation).

In embodiments, conductive fasteners 156 may comprise screws including hexagonal sockets positioned at the heads of the screws. Fasteners 156 may also be made of stainless steel, coated in nickel, and/or plated in gold in order to increase the anti-corrosion properties and electrical conductivity of fasteners 156. In embodiments, fasteners 156 may comprise/be coated and/or plated with materials that may provide similar anti-corrosion properties and electrical conductivity to those materials disclosed above. In additional embodiments, any orifices utilized by conductive fasteners 156 may be coated in an electrically conductive material in order to continue the circuit within chip 172.

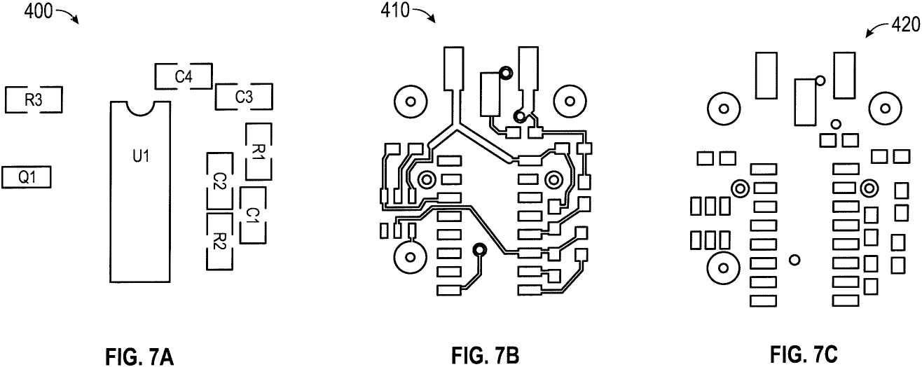

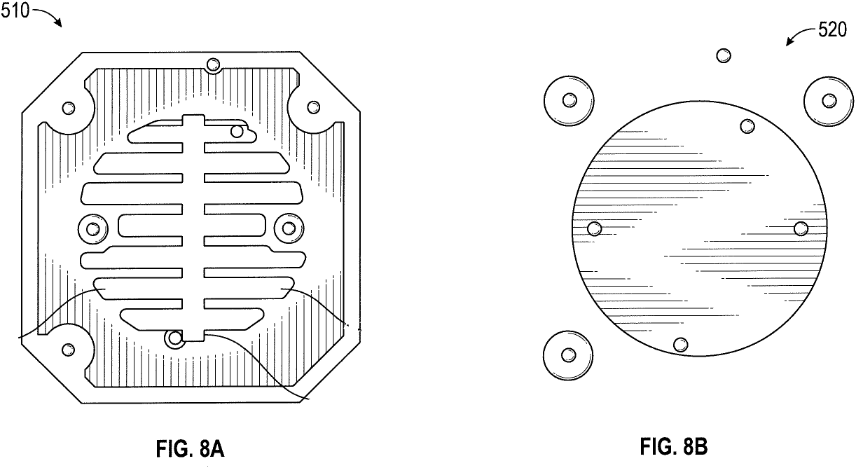

FIG. 7A displays a reference designator diagram 400 of a printed circuit board (PCB) 170 in accordance with embodiments. Each labeled element may correlate with an element positioned on the top solder mask 420 so that circuit board 170 may efficiently execute functions. It is noted that each of the labels refers to the following components: U1 (timer circuit 205), QI (first transistor 210), R1 (first resistor 240), R2 (second resistor 245), R3 (third resistor 250), C1 (first capacitor 220), C2 (second capacitor 225), C3 (third capacitor 230), and C4 (fourth capacitor 235). FIG. 7B displays a top copper layer 410 of a printed circuit board (PCB) 170 in accordance with embodiments. Top copper layer 410 may be covered by top solder mask 420 (FIG. 7C) so that the proper portions of the circuit on PCB 170 are exposed and covered.

FIG. 8A displays a first printing layer 520 of a printed circuit board (PCB) 170 in accordance with embodiments. Once first printing layer 520 is printed on PCB 170, an exposed nickel treated cathode layer 510 (as shown in FIG. 8B) is printed on top of first printing layer 520. Once positioned within electrolytic generator apparatus 105, cathode layer 510 may be positioned adjacent to and protected by membrane 160. This is especially important considering that the environment the cathode layer 510 is utilized in is a liquid solution.

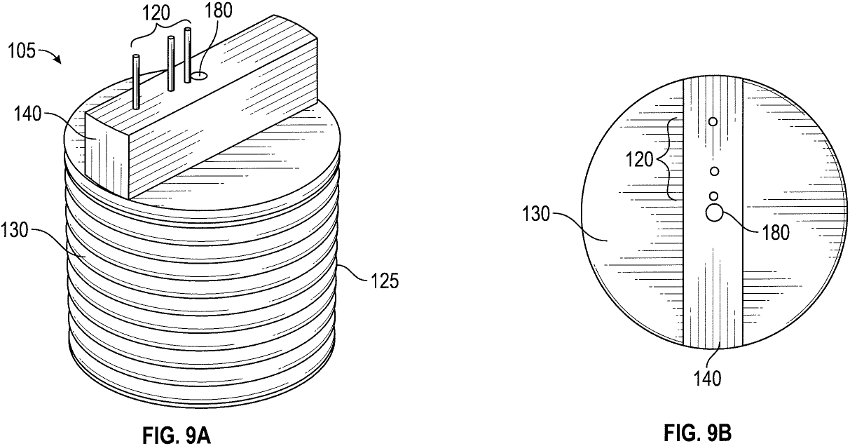

FIG. 9A displays a perspective view of an alternative electrolytic generator 105 in accordance with embodiments. As shown, two pins of pinheader 120 are grouped together and a third pin is spaced apart from the group. The spatial dimensions of the configuration may be additionally shown in FIG. 9B. In addition, hydrogen is an additional byproduct that is given off in the form of a gas and is led out of the bottom of lower housing 140 and out of apparatus 105 entirely through vent hole 180 (see FIG. 9B) that is associated with cathode 190.

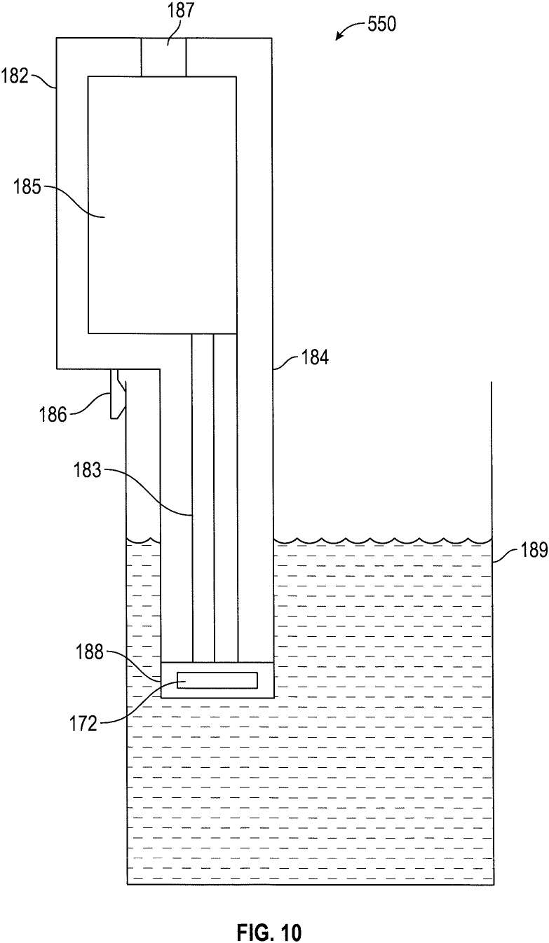

FIG. 10 displays a sectional view of an alternative electrolytic generator apparatus 105 configured to sanitize liquids in a handheld liquid container 189 in accordance with embodiments. Apparatus 105 may comprise a top housing 182 and a lower chip housing 188 containing chip 172 that extends away from top housing 182 on a lower end of top housing 182. Chip 172 may be positioned at the bottom of lower chip housing 188 so that lower chip housing 188 may effortlessly submerge chip 172 into a liquid container 189. A voltage regulator housing 182 may house a voltage regulator with capacitor 185 configured to regulate the voltage to and from chip 172. Internal componentry housing 183 may extend from chip 172 to voltage regulator housing 182 and may protect internal components of apparatus 105 from getting wet and malfunctioning. A retainer 186 may be positioned on a lower end of top housing 182 adjacent lower chip housing 188 so that apparatus 105 may securely affix to liquid container 189, eliminating the necessity for a user to hold apparatus while it functions. In addition, top housing 182 may include an input portion 187 for providing an input to a charging cable or device so that apparatus 105 is provided power.

FIG. 11A displays a perspective view of a water purification system 100 in accordance with embodiments. Water purification system 100 may comprise a container 10, filter 20, and lid 30. As shown in FIG. 11B, an electrolytic generator apparatus 105 may be positioned on the bottom interior of container 10 so as to be in a position to efficiently purify water as well as release gas byproducts. In order to purify a liquid, electrolytic generator apparatus 105 may utilize an anode 150, a cathode 190 affixed to a printed circuit board (PCB) 170, and a membrane 160 (see additional FIGS.). When the electrolytic generator apparatus 105 is positioned in the container 10 in the presence of an electrolyte (in this case, salt) and provided an electric current from power source 60, electrolysis may occur so that chlorine gas and other chlorine compounds disinfect/purify the water contained in container 10. Once the water is purified, it is noted that in embodiments, between 3.5 g and 5 g of salt are added for each liter of water in container 10 in order to efficiently disinfect the water.

It is further noted that electrolytic generator apparatus 105 may be of an optimal size and cost to be utilized in water purification systems that may be portable, inexpensive, and simplistic; this may be advantageous in terms of providing clean water to third world countries or places where other technologies may not be found or work

Switch 270 may be electrically affixed to a circuit of a water purification system 100 so that when switch 270 is actuated, electrolysis is carried out and the water poured out of the spigot 40 is purified.

In embodiments, power source 60 may be a dynamo (as shown) or may be some other type of power source that provides DC current such as, but not limited to, a battery, a solar cell, etc. When a dynamo is utilized, a voltage regulator with a capacitor may be connected into the circuit between the dynamo and electrolytic generator apparatus 105 in order to charge the capacitor and then release stored electricity, generated from the dynamo. A user engagement portion, such as a button, may control the release of the electricity produced so that the proper amount of electricity is run through electrolytic generator apparatus 105.

In embodiments, filter 20 may be a biomass filter that is capable of adsorption to capture unwanted active/inactive compounds in filter 20 due to the presence of carboxylic groups and lignocellulosic materials engrained in different stages of the filter. Materials incorporated into filter 20 may include one or more of kenaf, roselle (hibiscus), cilantro, pumpkin, alfalfa grass, activated carbon coconut husks, kaolinite clay, and carica papaya seeds. Active and inactive compounds that may be captured and stored in filter 20 may include, but is not limited to: Au³⁺, UO₄, ^{U2-}, Cd²⁺, Hg²⁺, Au(CN)²⁻, Cu²⁺, Pb²⁺, VO₄, V³⁻, MoO₄, Mo²⁻, Zn²⁺, CR³⁺, CrO_{4.0}, CXr²⁻, Ni²⁺, A_{S}O₄, As³⁻, Co²⁺, Mₙ²⁺, Fₑ³⁺, Ag⁺, AL³⁺, Mg²⁺, PFAS, and hydrocarbons.

In further embodiments, filter 20 may comprise multiple layers that may each comprise at least one of the aforementioned materials. Each of the layers may be responsible for capturing one or more contaminants, which may lead to an exchange of ions (and an altering of the charge/conduction state of the filtered water). Fluidized sintered plates may be positioned within the layers of filter 20 in order to assist with altering the charge of the filtered water once ion exchange has taken place in one or more layers. In embodiments, the fluidized sintered plates may comprise at least one of a polymer, a metal, and a biodegradable polymer.

In embodiments, the lifespan of container 10 may be 100,000 gallons. In additional embodiments, the lifespan of printed circuit board (PCB) 170 may be two years. In additional embodiments, the lifespan of filter 20 may be three months.

It is noted that impurities found in the water may be removed in two separate stages, increasing the efficacy of water purification. Biologically inactive impurities, such as those listed above, may be removed first by filter 20, while biologically active impurities (viruses, cryptocides, bacteria, etc.) are removed second via electrolysis of the water by electrolytic generator apparatus 105.

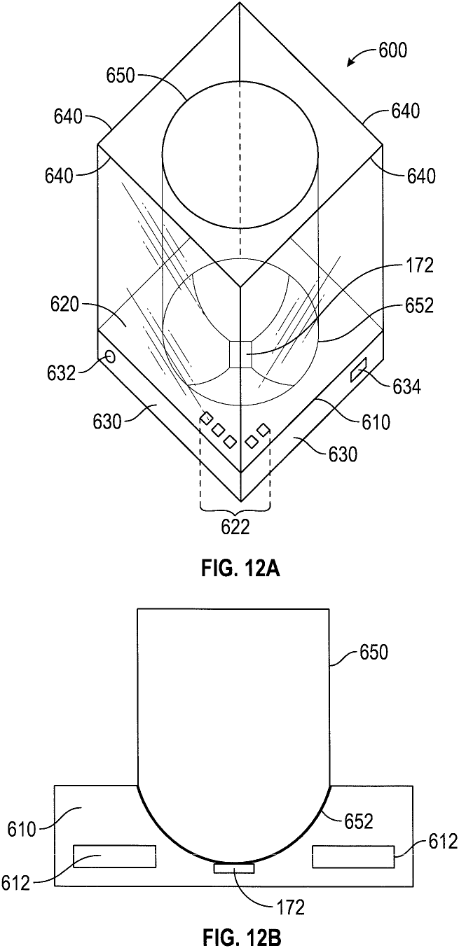

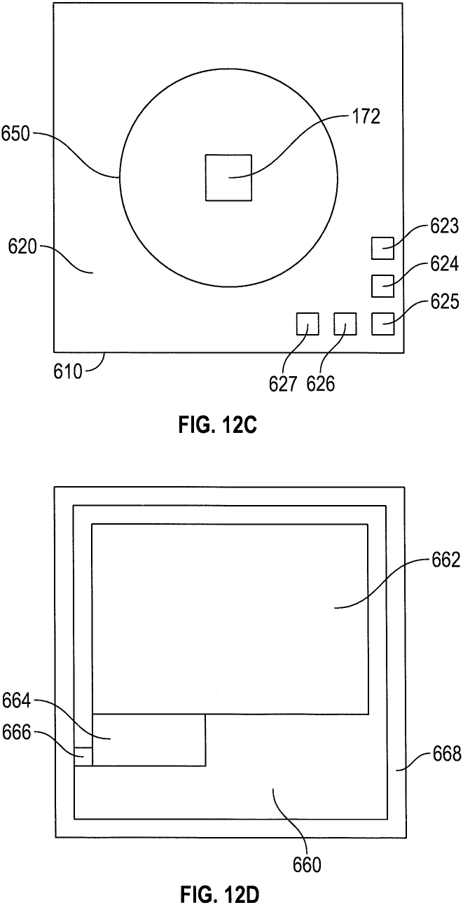

FIG. 12A displays a perspective view of an alternative water purification system 600 in accordance with embodiments. System 600 may include a base 610 including side surfaces 630. Side surfaces 630 may house components such as, but not limited to a solar power input 634 and a dynamo input 632. Along each edge of base 610, sidewalls 640 are positioned and form a volume above base 610. A divot 652 may be centered within base upper surface 620 and is configured to receive a concave bottom of container 650. Chip 172 may be positioned at the bottom of divot 652 so that chip 172 may effectively sanitize water/liquid housed in container 650. Upper external componentry 622 may also be positioned on base upper surface 620 so that a user of system 600 may easily control system 600 as well as view statuses of functions being performed by system 600 via indicators such as, but not limited to LEDs. As shown in FIG. 12C, upper external componentry 622 may include start actuator 623, cycle completion LED 624, dynamo charging LED 625, solar power charging LED 626, and power ready LED.

FIG. 12B displays a side sectional view of an alternative water purification system 600 in accordance with embodiments. As shown, internal electronic componentry 612 may be positioned within base 610 and adjacent divot 652. FIG. 12D displays a bottom view of a lid 660 of an alternative water purification system 600 in accordance with embodiments. Lid 660 may include a solar panel 662 connected to a microcontroller 664, which provides a solar panel output to solar output 666. When lid 660 is installed on system 600, solar output 666 may be electrically connected to solar power input 634 so that chip 172 may be provided a power source. In addition, a gasket channel 668 may be provided within the structure of lid 660 so that a gasket may be positioned within lid 660, allowing lid 660 to seal with sidewalls 640 more effectively.

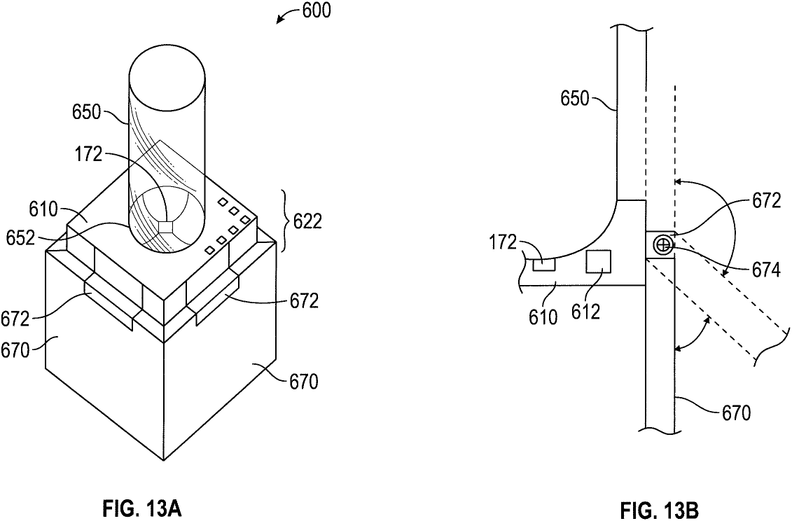

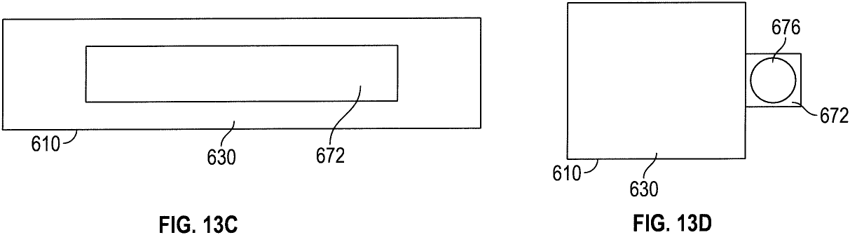

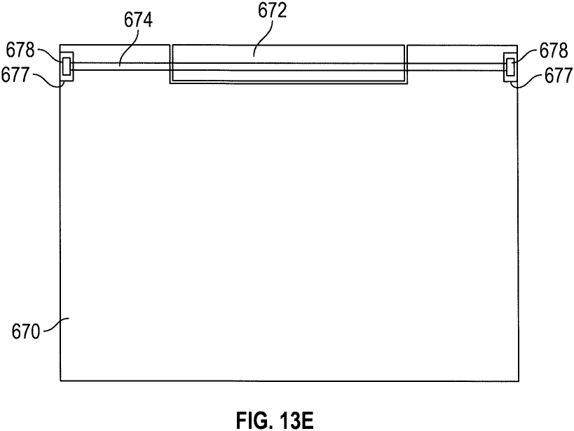

FIG. 13A displays a perspective view of an alternative water purification system 600 including configurable side panels in accordance with embodiments. System 600 of FIGS. 13A-13E may comprise a base 610 configuration similar to the embodiments of system 600 found in FIGS. 12A-12D and may similarly include upper external componentry 622, divot 652 positioned within base 610, chip 172 positioned within divot 652, and container 650 positionable within divot 652. System 600 of FIGS. 13A-13E may additionally include convertible side panels 670 that may be configured to pivot 180 degrees from a standing configuration (as shown in FIG. 13A, convertible side panels 670 may provide support as a stand for base 610) to an outer container configuration (FIG. 13B). As shown in FIG. 13B, panels 670 may affix to pivot blocks 672 located on each side of base 610. In order to secure panels 670 inside of pivot blocks 672, through pins 674 may be positioned in through holes 676 (see FIG. 13D) formed by the connection between base 610 and panels 670. This may allow panels 670 to pivot form a downward configuration into an upward configuration; this may allow for ease of transport for system 600. As shown in FIG. 13C, pivot blocks 672 may extend along a majority of the length of base side surfaces 630; this may provide increased stability to panels 670. FIG. 13E displays a side view of a panel 670 affixed to a pivot block 672 of base 610 via through pin 674. In order to keep the through pin 674 positioned within through hole 676, pin retainers 677 may be affixed to the ends of through hole 676; due to the fact that the pin retainers 677 are larger in diameter than through hole 676, through pin 674 may be prevented from moving laterally. Additionally, recesses 678 may be positioned at top upper sides of each panel 670 so that recesses 678 do not protrude out of the sides of panels 670.

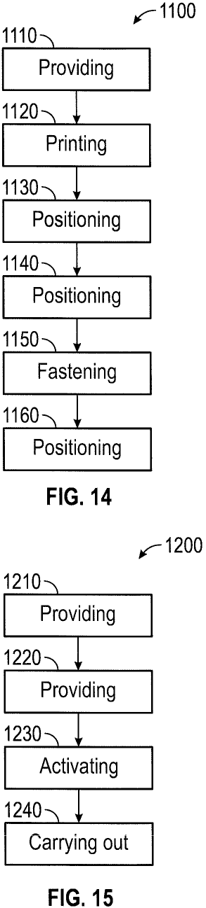

FIG. 14 displays a method 1100 for manufacturing an electrolytic generator apparatus 105. Method 1100 may include providing 1110 a PCB 170. A first electrode may be printed 1120 onto one side of the circuit board 170 and may act as cathode 190. A membrane 160 may be positioned 1130 adjacent the cathode 190 and a second electrode (anode 150) may be positioned 1140 on the side of the membrane 160 opposite the side of the membrane 160 facing cathode 190. Anode 150 is then fastened 1150 to the circuit board 170 via conductive fasteners 156 so that anode 150, cathode 190, and circuit board 170 are electrically connected. The components above are then positioned 1160 in a fastenable housing 130,140. For clarification purposes, the term "fastenable" in this context may refer to the fact that the housing 130,140 is fastenable to a container 10 (or another part of a water purification system 100).

FIG. 15 displays a method 1200 for disinfecting water. Method 1200 may include providing 1210 a container 10 having an electrolytic solution and an electrolytic generator apparatus 105 housing a printed circuit board (PCB) 170. A power source 60 may be provided 1220, affixed to the electrolytic generator apparatus 105, and activated 1230 to start the electrolytic reaction in container 10. The electrolytic reaction may then be allowed to carry out 1240 for a preset amount of time based on the configuration/componentry of the printed circuit board 170.

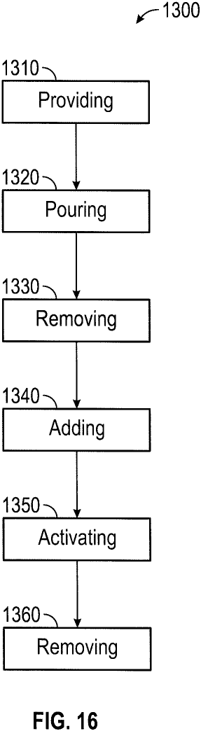

FIG. 16 displays an alternative method 1300 for disinfecting water. Method 1300 may include providing 1310 a container 10 having a filter 20 and an electrolytic generator apparatus 105 housing a circuit board 170 and connected to a power source 60. Unsanitized water may be poured 1320 through the filter 20 of the container 10. When the water is being poured through the filter 20, biologically inactive compounds are removed 1330 and trapped in filter 20. Once this is complete, an electrolyte may be added 1340 to the water and the power source 60 may be activated 1350 in order to start an electrolytic reaction in container 10. During the time that the electrolytic reaction occurs, biologically active compounds are removed 1360 from the water, leaving an end product of purified water.

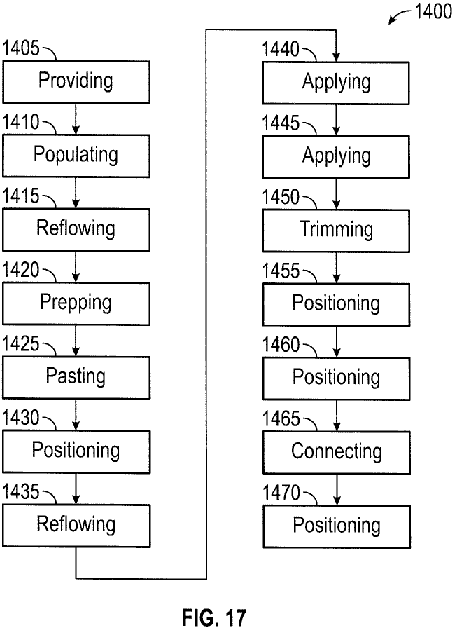

FIG. 17 displays a method 1400 for assembling an electrolytic generator apparatus 105. Method 1400 may include providing 1405 a PCB 170 including a printed cathode 190 on a top side of PCB 170. Components on a bottom side of PCB 170 (opposite side of location of cathode 190), except for pinheader 120, may then be poplulated 1410 and reflowed 1415. Next, one or more conductive spacers 152 may be prepped 1420 in order to be soldered to a top side of PCB 170 (side including cathode 190). One or more portions of a spacer, which may include one or more layers of the spacer, can include one or more washers and in some instances by way of example, up to ten washers. In order to prepare the spacers 152, the one or more conductive spacers 152 may first be sprayed (on one side) with solder flux 1415 (or a similar flux). Once sprayed, the spacers 152 may then be rinsed with water and dried. It is at this point that the top side of PCB 170 may be solder pasted 1425 (cathode 190 side) and the conditioned side of spacers 152 may be positioned 1430 on the top side of PCB 170 so that they are centered on cathode 190. It is noted that spacers 152 may not encroach/cover orifices 110 that are located within the profile of PCB 170. Because of this, spacers 152 may include a hollow interior (similar to the construction of a washer). Once the one or more spacers 152 are positioned 1430, the top side of PCB 170 may be reflowed 1435 and gasket 154 may be applied 1440 to the top side of PCB 170 centered around spacer 152 so that gasket is adequately adhered to PCB 170.

Once gasket 154 is applied 1440, membrane 160 may then be applied 1445 on top of gasket 154. It is noted that when membrane 154 is applied 1445, membrane 160 may be applied 1445 with the smoother/glossier side facing cathode 190 in order to avoid damage to membrane 160. Excess material extending past 0.01-0.02 inches of the border of PCB 170 may then be trimmed 1450. At this point, anode 150 may then be positioned 1455 so that anode 150 may allow for the insertion of screws into the plated through holes (at opposite corners) of PCB 170. Conductive fasteners 156 may then be positioned 1460 within the through holes. Next, pinheader 120 may be connected 1465 to the bottom side of PCB 170 and chip 172 (PCB 170 and added components) may then be positioned 1470 within housing 125.

In embodiments, in the case where membrane 160 comprises Nafion® (a registered trademark of Dupont), Nafion may be pretreated in alkaline water, due to the Nafion being shipped in the "Dry" H+ form.

In the aforementioned methods 1100,1200,1300,1400 any of the steps described may be carried out in an order that is different than that which is disclosed.

In embodiments, various attachment and fitting techniques and equipment (male-female engagement, fastening means, adhesives, magnets) may be utilized in any of the disclosed embodiments in order for components of the embodiments to efficiently and/or properly attach to one another and so that water purification system 100/electrolytic generator apparatus 105 can efficiently and/or properly function. For example, electrolytic generator apparatus 105 may comprise a male snap lock engagement portion while water purification system 100 may comprise a female snap lock engagement system, as opposed to both including threads.

For the purposes of this disclosure, the terms "circuit board", "printed circuit board", and "PCB" may be synonymous.

For the purposes of this disclosure, the terms "electrolytic generator" and "electrolytic generator apparatus" may be synonymous.

It is noted that upper housing 130 and lower housing 140 may be referred to collectively as "housing".

In embodiments, upper housing 130 may comprise a height of at least one of 0.5 inches and 0.75 inches. In embodiments, upper housing 130 may comprise a width in the range of 0.99 inches and 1 inch.

In embodiments, lower housing 140 may comprise a height in the range of 0.25 inches and 0.3 inches. In embodiments, lower housing 140 may comprise a length in the range of 0.909 inches and 1.1 inch. In embodiments, upper housing 130 may comprise a width in the range of 0.25 inches and 0.375 inches.

In embodiments, printed circuit board 170 may be a flexible circuit board.

In embodiments, anode 150 may comprise titanium. In embodiments, cathode 190 may comprise at least one of plated nickel and plated gold.

In embodiments, water in container 10 may be any other form of liquid that may need disinfection.

A plurality of additional features and feature refinements are applicable to specific embodiments. These additional features and feature refinements may be used individually or in any combination. It is noted that each of the following features discussed may be, but are not necessary to be, used with any other feature or combination of features of any of the embodiments presented herein.

Unless otherwise defined, all technical and scientific terms used herein have the same meanings as are commonly understood by one of ordinary skill in the art to which this disclosure belongs. Although methods similar or equivalent to those described herein can be used in the practice or testing of the present disclosure, suitable methods are described herein.

All publications, patent applications, patents, and other references mentioned herein are incorporated by reference in their entirety. In case of conflict, the patent specification, including definitions, will prevail. In addition, the materials, methods, and examples are illustrative only and not intended to be limiting.

It will be appreciated by persons skilled in the art that the present disclosure is not limited to what has been particularly shown and described hereinabove. Rather, the scope of the present disclosure is defined by the appended claims and includes both combinations and sub-combinations of the various features described hereinabove as well as variations and modifications thereof, which would occur to persons skilled in the art upon reading the foregoing description.

I claim:

1. An electrolytic generator apparatus for disinfecting liquids, the apparatus comprising:
a housing including a first end including an orifice, a second end, and at least one sidewall connecting the first end and the second end;
a first electrode at least partially positioned adjacent the orifice;
a second electrode positioned on a printed circuit board positioned within the housing, the second electrode facing the first electrode;
a membrane positioned between and separating the first electrode and the second electrode; and
a plurality of conductive fasteners contacting the first electrode and extending through the first electrode, the membrane, and the printed circuit board, the plurality of conductive fasteners configured to provide an electrical connection between the first electrode and the second electrode.

2. The apparatus of claim 1, wherein the first electrode comprises a cathode and the second electrode comprises an anode.

3. The apparatus of claim 1, wherein the cathode is printed onto the printed circuit board.

4. The apparatus of claim 1, wherein the printed circuit board is electrically connected to a power source.

5. The apparatus of claim 1, wherein at least one of the first end, the second end, and the at least one sidewall comprises an affixing means configured to affix the apparatus to a liquid container.

6. The apparatus of claim 1, wherein the membrane comprises a cation exchange membrane.

7. The apparatus of claim 7, wherein the membrane comprises a conductivity of 0.2 S/m or greater.

8. The apparatus of claim 6, wherein the membrane comprises a minimum cell operation of 1.23 V.

9. The apparatus of claim 1, further comprising a plurality of vent orifices positioned on the second end of housing, the plurality of vent orifices configured to release hydrogen out of the housing.

10. The apparatus of claim 9 further comprising a plurality of vents, each of the plurality of vents positioned adjacent a respective one of the plurality of vent orifices.

11. A method for manufacturing an electrolytic generator, comprising:
providing a printed circuit board;
printing a first electrode onto a first side of the printed circuit board;
positioning a membrane between the first electrode and a second electrode, the second electrode positioned on an opposite side of the membrane;
fastening the second electrode to the printed circuit board via conductive fasteners so that the second electrode and the first electrode are electrically connected to the circuit board; and
positioning the printed circuit board, first electrode, second electrode, and conductive fasteners in a housing.

12. The method of claim 11, further comprising affixing a pinheader to the printed circuit board, the pinheader configured to extend through an end of the housing to provide an electrical connection outside of the housing.

13. The method of claim 11, further comprising providing a plurality of conductive fasteners to fasten the second electrode to the printed circuit board.

14. The method of claim 12, further comprising providing a plurality of conductive pathways extending through the second electrode, the membrane, the first electrode, and the printed circuit board, each of the conductive pathways configured to receive a respective one of the plurality of conductive fasteners.

15. The method of claim 11, further comprising providing an affixing means on an outer surface of the housing.

16. The method of claim 11, further forming an orifice on a first end of the housing, the orifice configured to expose the second electrode.

17. The method of claim 16, further comprising forming a plurality of vent orifices on a second end of the housing, the plurality of vent orifices configured to provide an escape for hydrogen produced during an electrolytic reaction.

18. The method of claim 17, further comprising positioning a respective one of a plurality of vents adjacent each of a respective one of the plurality of vent orifices.
